(19) United States
(12) Patent Application Publication
(10) Pub. No.: US 2016/0217876 A1
(43) Pub. Date: Jul. 28, 2016

(54) FABRICATION OF METALLIC NUCLEAR FUEL

(71) Applicant: Advanced Reactor Concepts LLC, Reston, VA (US)

(72) Inventor: Leon C. Walters, Idaho Falls, ID (US)

(21) Appl. No.: 15/003,329

(22) Filed: Jan. 21, 2016

Related U.S. Application Data
(60) Provisional application No. 62/108,933, filed on Jan. 28, 2015.

(51) Int. Cl. G21C 21/16; B22D 25/02; B22D 17/00

(52) U.S. Cl. CPC G21C 21/16; B22D 17/00; B22D 25/02

(57) ABSTRACT

Systems and methods for fabricating metallic nuclear fuels are described. Methods may include preparing a metal feedstock charge; injection casting the metal feedstock charge into one or more molds to form one or more injection cast fuel slugs; determining one or more properties of the one or more injection cast fuel slugs; inserting one or more injection cast fuel slugs with acceptable properties into one or more jackets to form a plurality of fuel pins; and assembling a plurality of fuel pins into a multi-pin fuel assembly. The method may produce at least one multi-pin fuel assembly per day, wherein each of the at least one multi-pin fuel assemblies includes at least one hundred fuel pins.

### CROSS REFERENCE TO RELATED APPLICATIONS

The present application claims priority to U.S. Provisional Patent Application No. 62/108,933, filed Jan. 28, 2015; the content of which are incorporated herein in its entirety.

### FIELD OF THE INVENTION

The present invention relates to systems and methods for metallic nuclear fuels, and more specifically, to systems and methods for fabrication of metallic nuclear fuels at commercial scale.

### BACKGROUND OF THE INVENTION

Metal fuel fabrication systems existed at small scales for the fueling of the relatively small reactors, such as the Experimental Breeder Reactor II (EBR-II), and the partial fueling of a larger reactor Fast Flux Test Facility (FFTF). These fabrication systems were not capable of meeting required capacities to concurrently fuel several nuclear reactors. Existing systems do not include advanced robotic technology and thus their capacity was limited by having multiple hands-on operations. Furthermore, existing fuel fabrication systems for ceramic fuel systems cannot be converted to use with metallic nuclear fuels because the pellets of ceramic nuclear fuels differ substantially from metal nuclear fuels.

A metal fuel fabricator for enriched uranium metal alloy fuel may be an important link in a supply chain for commercial, fast neutron nuclear power reactors. Certain reactors may operate the fuel at low power density with very long refueling interval. As such, each core loading may require an unusually large number of fuel pins relative to their power rating. The resulting production rate requirement is too large for lab-scale operations. Metal fueled fast reactors are under commercialization in several nations and the combined demand for fuel manufacture may become large in the future. A modern fabrication plant may be needed to satisfy the future level of manufacturing throughput rate.

Some recent metal fueled reactor designs are “fissile self-sufficient”. The burnup of the initial fissile loading is exactly compensated by internal breeding of replacement fissile material. Such designs facilitate favorable safety features including achievement of passive safety response and even passive load following. But the precision required in designing for a tradeoff of burned initial fuel for bred new fuel rests in part on a highly precise knowledge of the “as-manufactured” fuel composition and mass. This in turn places demands on manufacturing tolerances and product quality control. Along with the need to handle large fuel assemblies and high throughput rates for commercial scale fuel fabrication also comes an added requirement for tight quality control of knowledge of the delivered fuel composition and mass.

Needs exist for improved systems and methods for fabrication of metallic nuclear fuel for commercial-sized fuel assemblies and at commercial throughput rates.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary fuel pin according to one embodiment.

FIG. 2 shows an exemplary process sequence for fabricating a metallic nuclear fuel, according to one embodiment.

FIGS. 3a-3b show a graph based casting-crucible-charge blending process, according to one embodiment.

FIG. 4 shows an exemplary facility layout, according to one embodiment.

### DETAILED DESCRIPTION OF THE PREFERRED EMBODIMENTS

Systems and methods are described for using various tools and procedures for fabricating metallic nuclear fuels. In particular, the systems and methods may be used for any industry or purpose where fabrication of metallic nuclear fuels is needed.

### Overview

Systems and methods are described for the fabrication of metallic nuclear fuel. In certain embodiments, metal alloy fuel pins and/or fuel assemblies and/or fuel clusters may be provided. Processes may include physical operations used to manufacture the fuel pins, fuel assemblies, and/or fuel clusters. Analytical support services may be used to meet regulatory requirements. Certain embodiments may provide for commercial-scale manufacturing for large-sized fuel assemblies using modern manufacturing methods to attain the necessary commercial throughput rates.

A fabrication process for manufacturing uranium metal alloy fuel pins and fuel assemblies at commercial scale, including for fissile self-sufficient fast reactors may be provided. The process may have two branches: (1) the physical processes used to manufacture the fuel, and (2) the analytical support services used to meet regulatory compliance requirements, including tight quality control on fuel composition and mass.

Certain reactor cores may contain assemblies of several different uranium enrichments and also assemblies containing no uranium at all (control assemblies, reflector assemblies, shield assemblies, etc.). In certain embodiments there may be three or more different uranium enrichments loaded into fuel assemblies. Enrichment levels of uranium may vary from depleted uranium (for blankets) up to <20% for driver assemblies. Some fuel may contain plutonium mixed in the uranium alloy. Rigorous material safeguards and criticality safety regimes may be needed in a commercial scale fabrication facility.

For enriched uranium, operations can be conducted “hands on” with no need for heavy shielding.

Even with plutonium-bearing fuel, glovebox operations can be used if the Pu has no minor actinide and no fission product contamination (i.e., it originated from PUREX reprocessing).

Metallic nuclear fuel products may include various components and sub-components. In certain embodiments, metallic nuclear fuel products may include fuel pins, fuel assemblies, and/or fuel clusters.

The following are exemplary definitions for various components discussed herein.

A “fuel slug” may be a piece of metallic nuclear fuel, which may be inserted into a jacket. In certain embodiments, the fuel slug may be a solid piece of metallic nuclear fuel. In certain embodiments, the fuel slug may be generally cylindrical. In certain embodiments, the fuel slug may be a uranium and/or a plutonium alloy.

A “jacket” may be a combination of a cladding tube and one or more end plugs.

A “fuel pin” or “pin” may be a jacket that contains bond sodium and a fuel slug. The terms “fuel pin” or “pin” may be used interchangeably herein.

A “fuel assembly” or “fuel pin assembly” or “multi-pin fuel assembly” or simply “assembly” may be a duct that contains multiple fuel pins. The terms “fuel assembly” or “fuel pin assembly” or “multi-pin fuel assembly” or “assembly” may be used interchangeably herein.

A “fuel assembly cluster” or “assembly clusters” or simply “cluster” may be a grouping of fuel assemblies. The terms “fuel assembly cluster” or “assembly cluster” or “cluster” may be used interchangeably herein. In certain embodiments, the fuel assembly cluster may be an array of multiple fuel assemblies. The fuel assemblies may be coupled, bound, in contact, in communication, interconnected, or otherwise associated with one another. In certain embodiments, seven hexagonal fuel assemblies may be bound together with one fuel assembly in a center and six fuel assemblies in contact and surrounding the central fuel assembly, such as with one face of the each of the outer fuel assemblies contacting one face of the central fuel assembly.

A “core” may be a grouping of one or more fuel assembly clusters.

For sizing a facility and its equipment, the following describes an exemplary fuel pin, fuel assembly, and fuel assembly cluster for a reactor operating at low power density with a 20 year whole core refueling interval. This example is for illustrative purposes only as different power densities, refueling intervals, and other variable may affect the facility, equipment, and/or processes. An exemplary core may have approximately 92 fuel assemblies, each with approximately 127 fuel pins. There may be assemblies for three enrichment zones as follows:

Inner Core: E=10.1%, 28 assemblies, 3556 pins

Middle Core E=12.1%, 28 assemblies, 3556 pins

Outer Core E=17.2%, 36 assemblies, 4572 pins

Totals: 92 fuel assemblies and 11684 pins per overall core

All values are approximate and may vary depending on particular uses and operations. In certain exemplary embodiments, metal alloy fuel slugs may have a 90% uranium/10% zirconium composition. In certain embodiments, the fuel slugs may be injection-cast, but other types of fabrication may be used as well.

Masses: The total heavy mass of a whole core loading may be approximately 20.7 tons of heavy metal. This amounts to approximately 1.77 kg HM/pin.

Geometry of Pins: All pins may have identical geometry, and may vary only in enrichment. The following are exemplary geometrical characteristics of the fuel pins: approximately 150 cm of fuel, approximately 60 cm of lower shield, approximately 225 cm of upper gas plenum, approximately 475 cm overall pin height including approximately 40 cm allowance for upper and lower fittings—all enclosed in a cylindrical cladding made of stainless steel. Pin cladding outside diameter (OD) of approximately 1.298 cm, and thickness of approximately 0.050 cm, total weight of pin less than approximately 4.6 kg.

Geometry of fuel assembly ducts: There may be 127 pins per assembly and they may be assembled into ducted assemblies, such as hexagonal ducted assemblies. Each of the ducts may be approximately 488 cm tall. All 92 assembly ducts may have the same geometry. All 127 pins in any one assembly may have the same enrichment. Duct dimensions may include outside flat to flat distance of approximately 16.15 cm, and thickness of approximately 0.30 cm. An assembly, loaded with fuel pins, may weigh approximately 525 kg.

Geometry of Clusters: Clusters of 7 assemblies may be tied together for the purpose of fuel handling during refueling operations. Each of the clusters may be approximately 518 cm high and may fit through an approximately 45 cm hole in a reactor top deck. There may be 14 seven-assembly clusters per core. There may be four seven-assembly clusters in an “inner” ring and ten seven-assembly clusters in an “outer” ring. The clusters may span across core enrichment zones and across orificing zones; as a result, each cluster is for a specific position in the core and for a specific azimuthal orientation. Therefore, the lower pole piece on each cluster lower fitting may have splines such that it can enter only its unique position and orientation in the reactor grid plate.

### Exemplary Facility Throughput Rate

For illustration purposes only, a 60 tons heavy metal (HM)/year (i.e., 3 cores/year) facility capacity is described herein. For purposes of this disclosure, “heavy metal” refers to uranium plus all trans-uranium elements. Throughput rates are calculated assuming one-shift operations. Capacity could be increased by: (1) going to multi-shift operations, or (2) installing additional process lines and vaults.

In certain embodiments, a rate limiting step for achieving commercial scale output may be capacity and batch rate of a furnace. Furnace capacity may be limited by criticality concern as only a set amount of metal feedstock may be processed at one time without the metal feedstock going critical. Certain embodiments may provide for use of two or more furnaces operating in parallel to increase throughput of the methods described herein. While other equipment described herein may be scalable to increase capacity, the furnaces may not be scalable and multiple parallel furnaces may be required to increase output to a desired amount.

In general, flow rates can be measured in number of articles processed per unit time. Various measurements may be used to determine the throughput and/or output of the systems and methods described herein.

In certain embodiments, the systems and methods may produce a number of fuel pin assemblies in a predetermined time period. The predetermined time period may be a day, a week, a month, a year, etc. In certain embodiments, the number of fuel pin assemblies produced in a predetermined time period may be one, two, three, four, five, ten, fifteen, twenty, etc. per day In certain embodiments, the number of fuel pin assemblies produced in a predetermined time period may be one per day. In certain embodiments, the number of fuel pin assemblies produced in a predetermined time period may be at least 50, at least 75, at least 100, at least 200, at least 250, at least 275, at least 300, at least 400, at least 500, or more in a year. In certain embodiments, the number of fuel pins in each fuel pin assembly may be more than approximately 50, more than approximately 100, more than approximately 150, more than approximately 250, more than approximately 300, etc. In certain embodiments, the number of fuel pins in each fuel pin assembly may be between approximately 100 and approximately 300 fuel pins.

The number of fuel assembly clusters produced in a predetermined amount of time may also be used as a measurement of productivity. For example, in certain embodiments the systems and methods may produce at least 50 fuel assembly clusters per year. In certain embodiments, the systems and methods may produce at least 30, at least 40, at least 45, at least 50, at least 55, at least 60, at least 65, at least 70, at least 75, at least 80, at least 90, at least 100, at least 110, at least 125, at least 150, or more fuel assembly clusters per year.

The number of cores produced in a predetermined amount of time may also be used as a measurement of productivity. For example, in certain embodiments the systems and methods may produce at least one core per year. In certain embodiments, the systems and methods may produce at least 2, at least 3, at least 4, at least 5, at least 10, or more cores per year.

In certain embodiments, the systems and methods may produce fuel pins of a predetermined length. The fuel pin length may vary depending on particular applications. In certain embodiments, the fuel pins may be between approximately 1 m and approximately 7 m, between approximately 2 m and approximately 6 m, or between approximately 3 m and approximately 5 m.

In certain embodiments, the systems and methods may require injection casting of a predetermined amount of enriched uranium alloy per day. In certain embodiments, the amount of enriched uranium alloy injection cast per day may be more than approximately 50 kg, more than approximately 100 kg, more than approximately 150 kg, more than approximately 200 kg, more than approximately 250 kg, more than approximately 300 kg, more than approximately 350 kg, more than approximately 400 kg, etc. In certain embodiments, the amount of enriched uranium alloy injection cast per day may be between approximately 150 kg and approximately 350 kg.

In an exemplary illustration, manufacturing of three cores per year may mean 92 fuel assemblies/core×3 cores/year=276 fuel assemblies/year. Assuming 250 working days a year and one 8-hour shift, the required throughput rate may be about 1 fuel assembly/day and about 127 fuel pins per day or about 16 fuel pins passing through each of the process steps each hour. To produce pins at approximately 16 pins/hr, may require up to 65 cast fuel slugs per hour. It may take approximately 3 or 4 cast fuel slugs to make a pin.

There may be approximately 14 fuel assembly clusters/core. They may be produced at approximately 1 cluster/wk and it may take approximately 7 assemblies to make a cluster.

Casting approximately 60,000 kg of heavy metal (HM) per year at 250 working days per year implies at least 240 kg of HM cast per day—more depending on the rejection rate.

Although the processes may be conducted “hands-on” and the fuel slugs and the fuel pins are light enough to be picked up by hand, the required pace may require reliance on mechanized equipment wherever feasible.

Assemblies and clusters are much too heavy for lifting by hand and may be 15 feet long. As such, mechanized handling may be required.

For certain embodiments, a fabrication method must meet the following requirements.

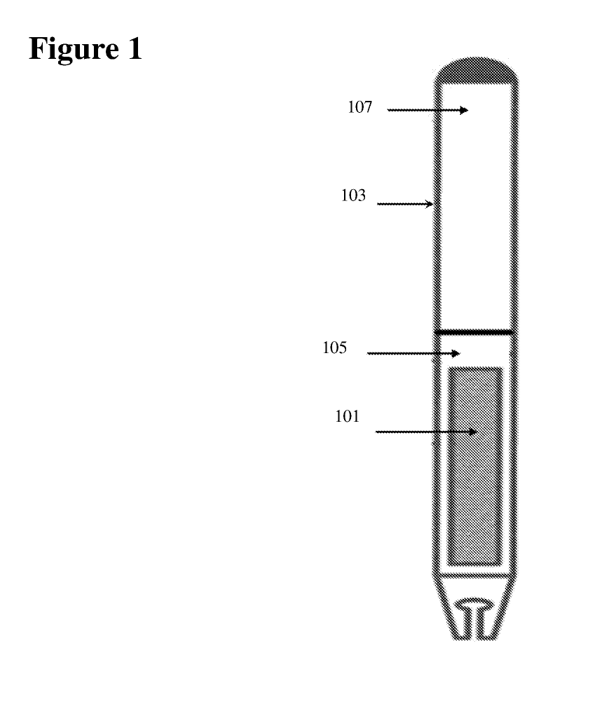

As shown in FIG. 1, a fuel slug 101, including uranium and/or zirconium may be located within a fuel jacket 103. In certain embodiments, the fuel slug 101 radial dimensions must be such that the fuel slug 101 occupies no more than 75% of the cross section area of the fuel jacket 103. The surface conditions of the fuel slug 101 may not be critical if the average diameter meets the requirement of 75% of the radial dimension or less. After a fuel slug 101 is cast there may be no need for surface preparation, such as grinding. In certain embodiments, the alloyed composition may exist in a homogenous state in the fuel slug 101.

A sodium bond 105 may provide a heat transfer path during an initial phase of irradiation. The integrity of the sodium bond may provide that no significant gaps exist between the fuel slug 101 and the fuel jacket 103. A significant gap may be large enough to create local melting of the fuel.

A plenum 107 above the fuel slug 101 may be sized to accommodate fission gas release and keep pressure low enough that the fuel jacket 103 is not significantly stressed. Top and bottom closures of the fuel jacket 103 may be welded in such a fashion that the risk of weld failure is extremely low.

Certain systems and methods may be used for the fabrication of fuel with fresh U-235 alloyed with additional elements, such as, but not limited to, zirconium. This fuel can be achieved primarily with the use of hoods and one glove box. In certain embodiments, more than one glove box may be used. For reprocessed metallic fuel, the operation may be carried out in a hot cell environment.

Fabrication technology may be described in various areas. There may be equipment necessary to fabricate the fuel. There may be analytical support that provides criticality safety requirements, analyses necessary to track the special nuclear material balances, and systems for providing identification and tracking of individual fuel pins.

### Fabrication Processes

The above-described metallic nuclear fuel products may be produced in a fabrication process. U.S. Pat. No. 2,952,056 is hereby incorporated by reference in its entirety as describing an exemplary apparatus and method for injection casting.

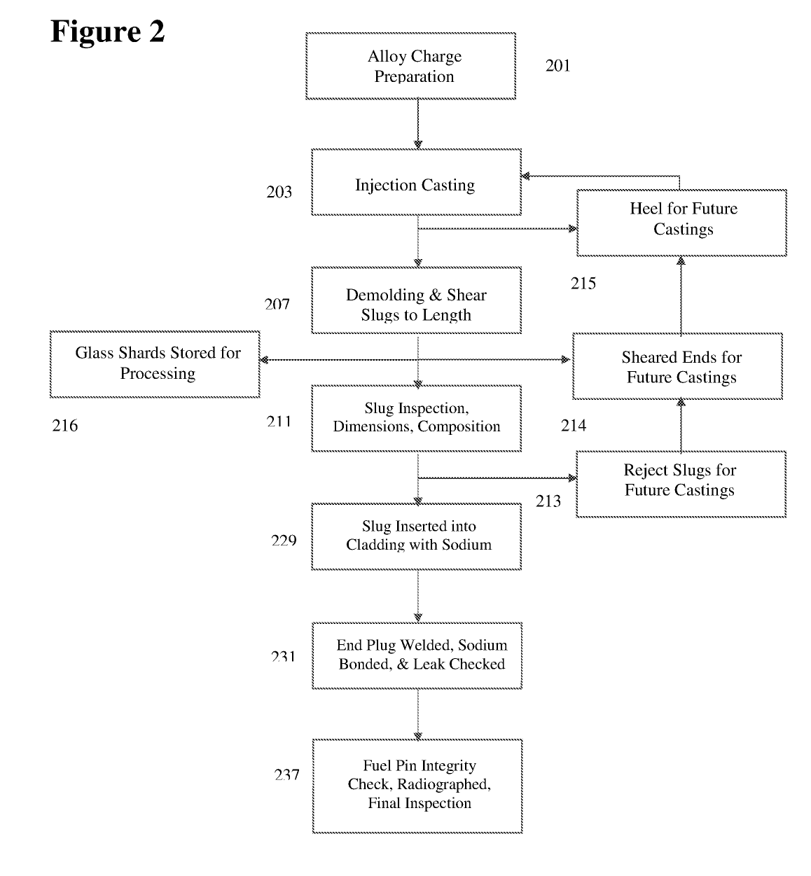

FIG. 2 is a flow chart showing an exemplary process for fabrication of metallic nuclear fuel. An initial step may be preparation of a charge consisting of the metal components. for a casting furnace 201. In certain embodiments, the charge may include uranium/zirconium. Other fuels and combinations are possible depending on the desired end product. The metal feedstock mix alloy ratios may be determined. The charge may be put in a crucible, such as a graphite crucible that had been coated with yttria. The crucibles may be re-useable for several castings. In certain embodiments, the crucible may be made of BeO. Crucibles of BeO may have the potential for multiple uses over that of graphite. The crucible may reside in a furnace, such as an induction injection casting furnace. An induction coil of the furnace may have at least two frequencies. In certain embodiments, a higher frequency may couple with the crucible, and a lower frequency may couple with the melt for stirring purposes.

The charge may be injection cast 203. The charge may be melted, such as by induction melting. The melt may be brought to temperature with enough super heat to ensure that the viscosity of the melt results in adequate flow of the liquid metal. The amount of super heat may depend on the specific alloy composition for the metallic nuclear fuel. For example, when using uranium/zirconium, the casting temperature may be in the range of approximately 1600 C. The heating of the melt may be performed under an inert atmosphere, such as an argon atmosphere. After adequate stirring of the melt, the furnace may be evacuated.

Molds, such as VYCOR or zirconium tubes, may be used. A pallet of molds, such as vycor molds coated with zirconia wash, may be positioned above the liquid metal. The ends of the molds may be inserted into the liquid metal and the furnace may be pressurized. Instantly or nearly instantly, the molds may be filled with liquid metal that immediately or nearly immediately solidifies. Parameters for the casting operation including quality of the mold wash, pressurization rate, and total pressure may be controlled.

In certain embodiments, the melt may be cast directly into zirconium tubes. By casting directly into zirconium tubes the vycor glass shards may be eliminated or reduced. Casting directly into zirconium tubes may take advantage of the observation that zirconium migrates to the surface of the fuel slug upon irradiation. The composite zirconium tube, with the fuel slug, may be put directly into the fuel jacket.

Injection casting technique may provide a compact method and may be adaptable to remote operations.

The injection cast fuel slugs may be de-molded 207. After the mold pallet is cooled, it may be removed from the casting furnace. Vycor glass molds may be broken away from the fuel slugs.

The fuel slugs may be cut/sheared to dimension 207.

Dimensions and impurities may be analyzed to determine if they are acceptable 211. The fuel slugs may be radiographed for the existence of voids. The average diameter of the fuel slugs may be measured with an air gage. If not acceptable, the fuel slug may be rejected and sent to metal recovery 213 for future casting. The recovered metal may be sent back as feedstock or may be sent to process waste.

Cropped/sheared ends 214 of the fuel slugs along with residual heal 215 in the graphite crucible may be stored for future castings. The broken glass shards 216 may be stored because they may contain small amounts of fissile material that must be recovered later. At least one fuel slug, from each batch, may be set aside for chemical analysis to determine composition and homogeneity.

The fuel slugs may be transferred to a helium atmosphere glove box. A furnace within the glove box may hold a number of fuel jackets or cladding that contains a specific quantity of sodium. The quantity of sodium may be carefully weighed to ensure just enough sodium is present to completely fill the gap between the fuel slug and fuel jacket. A radiograph showing the height of sodium in the cladding after the fuel slug has settled may provide assurance that no large voids exist in the gap. The furnace may be brought to a temperature so that the sodium is in a liquid state. A fuel slug may be loaded or inserted into each jacket 229. An end plug or cap may be welded to the fuel jacket 231. Each of the resultant fuel pins may be leak checked to ensure weld integrity.

The fuel pins may be removed from the glove box and transferred to a bonding furnace for sodium bonding 231. The bonding furnace may hold a number of fuel pins. The furnace may be brought to a predetermined temperature, such as approximately 500 C. At this temperature the sodium may wet the fuel jacket and fuel slug.

A top and bottom end closure and/or wire wrap may be added.

The fuel pins may be settled. The sodium thermal bond may be settled by various methods, including, but not limited to, either impaction or vibration to remove voids in the sodium bond.

After removal from the bonding furnace, the integrity of the sodium bond may be ensured by various techniques. One technique may involve eddy-current integration of the bond and the second may involve radiography to determine sodium height in the jacket 237.

Measurements and/or testing may be performed to determine if the fuel pins are acceptable. If not, the fuel pins are sent back to the sodium bonding system 231. If acceptable, the completed fuel pins are ready for fabrication of a fuel assembly prior to reactor insertion.

Several supply lines may be established for the consumable materials used in the fuel fabrication. For example, the casting furnace may require vycor molds, zirconia wash, graphite crucibles, yittria wash, as well as the fuel materials; uranium and zirconium. A supplier may be identified for the jacket components that includes the cladding tube, end fittings, and the wire wrap. Lastly, all components for the assembly that includes the hex duct, reflector blocks, and upper and lower end fitting may be fabricated by certified a vendor.

### Regulatory Requirements

The manufacturing operations to produce fuel slugs, fuel pins, and/or fuel assemblies may be subject to one or more sets of regulations. These regulations may affect how a fuel slug, fuel pin, and/or fuel assembly is fabricated as discussed below.

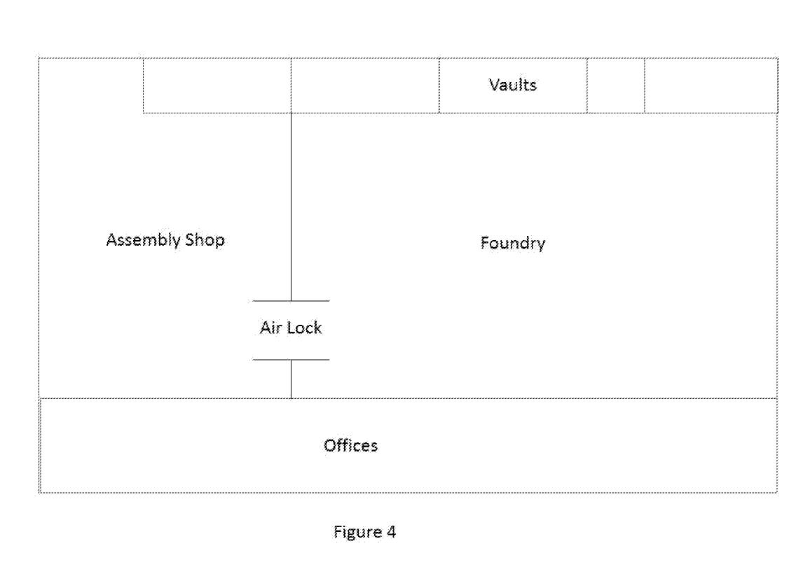

Manufacturing operations may be conducted in a facility whose features facilitate compliance with regulatory requirements. FIG. 4 illustrates (at an overview level) a topological organization that may comply with regulatory requirements. The facility main building may include three work areas or zones: (1) a Foundry where all operations on bare uranium (and plutonium) may be conducted: (2) an Assembly Shop where manufacturing operations on cladded pins to make assemblies and clusters may take place; and (3) an office area. The Foundry and Assembly Shop may include criticality-safe storage vaults for feedstocks and for work-in-progress. Completed clusters may be stored until the entire core can be shipped all at the same time. The Foundry and Assembly Shop zones and their associated vaults may be subdivided into “Material Balance Area” spatial subdomains (not shown) for the purpose of administrative control of fissile inventories. The Foundry zone of the facility may have a safety-grade atmosphere control system that maintains a slightly negative air atmosphere in the Foundry and may provide a filtered release to the atmosphere atop a tall stack. Shipping and receiving corridors may penetrate through a guarded safeguards fence that may encircle the fabrication facility and sets the protected boundary of the facility.

An exemplary system for fabricating metallic nuclear fuel may include an injection casting furnace for injection casting an metal feedstock charge to create one or more injection cast fuel slugs; an analysis unit for determining one or more properties of the one or more injection cast fuel slugs; a jacket insertion unit for inserting one or more injection cast fuel slugs with acceptable properties into one or more jackets; a bonding furnace for sodium bonding the one or more injection cast fuel slugs and the one or more jackets into one or more fuel pin assemblies; and an assembler for assembling a plurality of fuel pin assemblies into a multi-pin fuel assembly. In certain embodiments, the system may produce at least one multi-pin fuel assembly per day. Each multi-pin fuel assembly may include at least one hundred fuel pins.

### Analytical Support Systems

Analytical support systems may measure and/or track composition and weight of fuel slugs as they become components of other systems. Measuring and/or tracking may be performed in-process and/or for finished products.

A fabrication facility operating on enriched uranium feedstock may require a rigorous criticality safety regime, a safeguards regime, and a quality control regime. The facility may be an actively guarded controlled access space. Fissile-containing inventories of in-process items and finished product may be stored in vaults. The facility workspaces and vaults may be subdivided into administrative Material Balance Areas for safeguards control of enriched uranium inventories.

These interdependent regimes of material control may rely on a Materials Control and Accountancy (MCA) software system tightly integrated with the operating staff actions on the floor. The MCA system may maintain real-time inventories of fissile-containing material in each of the Material Balance Areas and vaults and may track the movements of fissile-containing “items” from one balance area to another. The “items” (such as cast slugs, fuel pins, fuel assemblies and fuel assembly clusters) may each be assigned a unique identifying tag number, and the MCA software may maintain its records of heavy metal mass, composition and location organized by item identification number. As cast slug items are incorporated into pins; as fuel pin items are incorporated into assemblies and as fuel assembly items are collected into clusters, the MCA software may keep track of the resulting masses and compositions of the new items so created.

Physical measurements on fissile containing material may be made as part of the fuel slug casting operations. Mass spectroscopy may determine enrichment and wet chemistry may determine alloying diluent content. Weights and dimensions may be by direct measurement. However, once the slugs are incorporated into pins, direct measurements (except for weight) become impossible, so the material control must thereafter rely on administrative procedures that rely on MCA records.

Proposed movements of items may first be checked for compliance with criticality safety constraints using the MCA database. Product quality control records may be generated using the MCA database. Safeguards inventory records may be based on the MCA database, and periodic physical inventories conducted on the Mass Balance Areas may be used to overcheck that the MCA records remain always consistent with the physical inventories.

### Training and Procedures

An important aspect of a fuel fabrication facility is training of all operators according to procedures written by the engineers who designed the equipment and provided the analytical support. Safety is the paramount consideration. Procedures and training of operators to prevent criticality accidents involves both the education of the operators and training according to procedures. Further, several operations involve high temperature, high pressure, and pyrophoric materials. A training department is necessary to ensure that all operators are qualified to operate safely.

Quality assurance of nuclear fuel must be guaranteed. Quality assurance principles may be embedded in all procedures and further a quality assurance department oversees the quality of the final product. A radiation safety department oversees all daily operations to ensure minimal radiation exposure.

The following are a few of the qualifications that operators must achieve: fuel handler; criticality safety; radiation safety; quality assurance; materials control and accountability; specific equipment qualification; glove box safety operation; and emergency response.

### Exemplary Processes for Meeting Fuel Composition Specifications

Manufacturing Tolerances on Fuel Slug Composition and Weight

Determining factors for reactor core performance may be (1) local density of U235 atoms (which may determine local power density); (2) whole-core integrated U235+U238 mass (which may determine criticality of the core and control rod requirements); and (3) local density of fertile U238 (which may determine in situ breeding of new fissile material).

The allowable extent of variation in these parameters may be pre-determined from campaigns of reactor performance computer calculations conducted to predict performance response to postulated deviations from specification. Allowable manufacturing tolerances may result from such computational studies and can become part of the manufacturing specification itself.

Allowable core criticality tolerance may benefit from cancellation, wherein a slightly over-enriched slug may be compensated by a slightly under-enriched slug, and repeated over thousands of slugs in a core. The local power density constraint may be much tighter because there is no canceling phenomenon.

Sensitivity calculations may prescribe allowable tolerances no larger than in the approximately 1-2% in slug composition.

### Uncertainty in the Crucible Charge

The crucible casting charges may be blended from stocks of reject slugs produced in previous castings, plus stubs generated from cropping to length of slugs from previous castings, plus crucible heels from previous casting lots, and from virgin uranium feedstock of various enrichments and virgin Zr alloying agent inventories. The blend of uranium-containing materials may be calculated to produce the targeted enrichment in the product slugs of the casting lot. Knowing the weight of the uranium in the charge and the Zr content of the various charged materials, any Zr feedstock can be added to the charge as needed.

In general, the blend may not conform absolutely to the specification because of measurement uncertainties which exist concerning the actual compositions of such blending materials.

### Uncertainty in the Cast Slug Composition

Blending of the casting crucible charge may aim to achieve a desired enrichment. The details of the process to be used for blending the crucible charge is described in a subsequent section below.

The casting operations from a given crucible charge may produce multiple slugs that are compositionally homogenous owing to vigorous stirring of the melt and rapid solidification of the casting. Therefore, a small sample of the batch can be measured, which can be used to determine the composition for the entire casting batch. When shearing the castings to length, several small fragments of the product may be sent to a chemistry lab where one is subjected to mass spectroscopy analysis to measure the enrichment. That enrichment may be assigned to all products of the casting batch. Another segment can be measured by wet chemistry to determine Zr/U ratio and that is assigned to the entire casting batch. The final fragment may be tagged with the unique casting batch number and placed in archival storage.

These measurements themselves may be subject to an uncertainty due to instrument precision and instrument calibration error.

The blending deviation may yield a deviation from specification, but it may be knowable from the direct measurements to within measurement uncertainty.

If the composition meets specification within the measurement uncertainty, the products of the casting batch can be cut to length, inspected and segregated into accepted and rejected slugs.

The accepted slugs may go into one box, while the rejects plus lopping scraps plus crucible heel may be loaded into another box. Each box may be weighed, tagged with a unique casting batch number identification tag and sent to the vault. Every box's contents will be fully characterized as to product composition and cumulative weight by direct measurement.

The boxes of accepted slugs may go to the vault to await their subsequent use for pin loading. The boxes of reject plus lopping fragments plus crucible heel may be saved to become feedstock for a subsequent casting batch.

Compositional deviations beyond a predetermined level may cause rejection of the entire cast batch, which may then go to a recycle inventory to be used in a future crucible charge.

### Rationale for Tracking Individual Fuel Slugs

Given that the measured composition of an as-cast slug meets the manufacturing specification within measurement uncertainty, one might simply assign the nominal target composition to it and thereafter treat all slugs as undifferentiated commodity slugs—relying on the central limit theorem to average out any slug to slug variations in the overall core loading. While this might be appropriate for some reactor types, it is not appropriate for fissile self-sufficient fast reactors. Instead, during fuel manufacture for such reactors, each slug may be treated as a unique “item” with its unique composition and weight and measurement uncertainty and may be tracked as it progresses through the manufacturing sequence becoming subsumed into unique pins and unique assemblies and clusters. This is done to avoid a stack up of blending deviation with measurement uncertainties and thereby to supply the product fuel with as high a degree of documented precision as possible.

There are several reasons for keeping track of each and every slug including those related to reactor performance and fuel cycle performance. First, the exemplary reactor considered here may be fissile self-sufficient meaning that internal breeding of Pu239 causes the fissile mass content of the reactor at end of life to be sufficient to fuel a replacement core after performing PYRO recycle steps to partially remove fission products and to replenish U238. Over a 20 year burn cycle, the net change in fissile mass content of the core (from the U235 present at beginning of life to the remaining U235 plus bred Pu239 present at end of life) may be the difference of two very large numbers, both of which have uncertainties. For example, during the 20 year burn cycle of the exemplary fissile self-sufficient reactor, on average across all fuel assemblies in the core, 8% of the heavy metal atoms are fissioned (20000 kg×0.08=1600 kg fissioned) while at the same time a compensating mass of Pu239 is bred as replacement. The net change in fissile content of the core is the difference of two large numbers, each one being of the order of 1600 kg, and the uncertainty in the net change gets amplified in relation to the uncertainties on the initial loading.

When the reactor performs as designed, the net change in reactivity is zero so the criticality of the core does not change, meaning that the reactivity vested in control rods can be designed to be nearly zero. This facilitates the implementation of passive safety response and of passive load follow features. On the other hand, if (due to a manufacturing deviation), the initial U238 content were too high by only 1%, the bred Pu239 content of the core at end of life would be too high by about 1% which would overcompensate the burnup of U235. The result would be an off specification burnup reactivity swing (requiring more control rod worth than had been provided for and impeding passive safety response) and an off specification radial power profile shift with burnup (requiring different flow orifacing than had been provided for). To avoid this, the as-manufactured composition and mass of the fuel loading has to be very close to specification, and its uncertainty must be quite small.

As regards to the fuel cycle, the calculated change in core composition combined with the measured initial composition and mass provides the basis for a safeguards declaration of fissile mass “input” to the PYRO recycle facility when the used core is recycled. This is different from the aqueous reprocessing of oxide fuel where an input tank is used to actually measure the inflow to the PUREX plant. The international safeguards limits on masses of receipts and shipments from reactor to recycle plant (and visa-versa) are very tight so the uncertainty in the calculated fissile content of the discharge core has to be maintained as low as possible. As above, its precision depends on the accurate prediction of the difference of two large numbers so the initial conditions have to have low uncertainties.

In summary, because of the sensitive self-compensation features of cores that are designed for fissile self-sufficiency, the as-built core must be known to conform as closely as possible to the assumptions used in the design and therefore actual, individual slug properties with as small as possible uncertainties are tracked individually to characterize the properties of the delivered fuel assemblies—rather than using nominal ones having a larger uncertainty band.

It is noted that in the future when recycle material and/or LWR used fuel are used as feedstock, their isotopic composition properties may be different from one casting batch to another. In that case, having already perfected the individual slug mass tracking process in the enriched uranium fabrication facility considered here may provide a benefit to the operation of the PYRO recycle facility.

Detailed Process for Blending Feedstocks for a Crucible Charge

Multiple and diverse material feedstocks may be blended to produce a crucible charge. The feedstocks may vary depending on the desired crucible charge but in general may include recycle material from previous casting batches, virgin enriched uranium (<20% enriched), virgin depleted uranium and virgin Zr or other alloying agent.

The exemplary core may include assemblies of three enrichments: 28 assemblies of 10.1% enrichment; 28 assemblies of 12.1% enrichment; and 36 assemblies of 17.2% enrichment. Multiple casting batches may be required for each enrichment level.

For each casting batch, a crucible loading may be prepared to the targeted composition, targeted enrichment level, and targeted total mass of alloy by blending feedstocks made of:
reject slugs plus cropping stubs and crucible heels from previous casting batches;
virgin depleted uranium metal;
virgin approximately 20% enriched uranium metal; and
virgin Zirconium metal.

The composition (Zr/U weight ratio) and enrichment (E) may be known to within measurement accuracy for each of the feedstocks.

The reject slugs plus cropping stubs and heels from previous casting batches may have been segregated into separate inventories organized by casting batch. Each inventory's composition and enrichment may be uniform among all pieces making up the inventory—even though there may be slight variations inventory to inventory.

When preparing a crucible charge of specified total mass, the inventories of reject slugs plus cropping stubs and heels should normally be used up first. Then a blend of virgin depleted U and virgin 20% enriched uranium may be added so as to attain the targeted uranium content and enrichment level. Finally, virgin Zirconium metal may be added to bring the Zr/U ratio up to specification.

Presumably, the total mass of rejects plus cropping stubs from any previous casting batch may be much less than the total mass of a crucible charge.

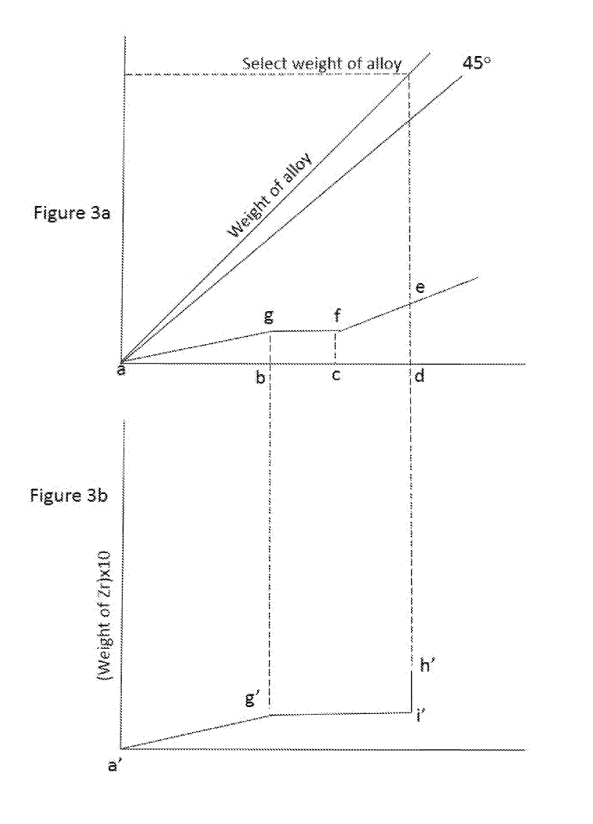

A graphical-based procedure for determining a metal feedstock ratio is illustrated by FIGS. 3a and 3b. A graph-based procedure may be used to determine masses to be supplied from each of the feedstocks so as to attain the targeted enrichment, the targeted composition and total alloy mass in the crucible charge. The independent variable (shown on the horizontal axis in FIG. 3) may be uranium mass. The vertical axis may show three dependent variables: wt of U235, wt of alloy, and wt of Zr. In terms of the independent variable (wt of U), the dependent variables may appear on the graph as straight lines of a given slope:
wt of dependent variable=(slope)×(wt of U)
wt of U235=(E)×(wt of U)
wt of alloy=(1/0.90)×(wt of U)
wt of Zr=(0.1)×(wt of alloy)=(0.1/0.9)×(wt of U)

Here, the blending process may be illustrated for a 17.2 enrichment casting batch with reference to FIGS. 3a and 3b. FIG. 3a shows wt of alloy vs wt of U. First, select the desired total mass of alloy for the crucible loading on the vertical axis and that determines the total mass of U on the horizontal axis (line a to d). Then on a vertical line rising from point d, the process may mark a point (point e) at the target enrichment of 17.2%.

In certain embodiments, all the scrap plus cropping stubs from previous 17.2% casting batches may be used first (line segment a to g)-(line segment a to b on the horizontal axis). Next, pass a 20% enrichment line through the target point e and pass a 0% enrichment (i.e., depleted U) line through the terminus point of scrap inventory (point g). These two lines intersect at point f, which thereby specifies the masses of depleted U (line segment b to c) and of 20% enriched (line segment c to d) to be added into the crucible charge.

At this point, the targeted total mass of U and the mass of U235 have been achieved, and it only remains to adjust the Zr content of the charge. (See FIG. 3b where the segments (a to b), (b to c) and (c to d) have been dropped down from FIG. 3a to FIG. 3b.

The reject plus stub inventory already charged may have contributed some Zr mass to the charge (line segment a′ to g′ in FIG. 3b). But the depleted and 20% enriched masses already charged have contributed no Zr, so the charge is Zr deficient. Therefore, a charge of virgin Zr of mass (h′ minus i′) has to be added to bring the composition (Zr/U ratio) up to specification.

This graph-based blending procedure may be implemented as a software application. It may provide a visual and intuitive tool for the operators who could “drag and drop” lines of different slopes to visualize where they intersect. Meanwhile the software may solve analytic geometry equations to determine line segment lengths to a precision not available by reading the graph, and would calculate and/or display blending recipes for the operators to weigh out when preparing the crucible charge.

More complex situations may be readily incorporated into the software. For example, when there are multiple inventories of rejects and stubs to be used up, a sequence of segments (perhaps of differing slopes) may comprise line a to g in FIG. 3a. Note that the total amount of U235 in a core loading is fixed from the start. Therefore, so long as all the rejects and stub are used up, it may not change the total core mass of U235 even if one were to use low enriched rejects and stubs in preparing charges for higher enriched pins. However, it would increase the cost. That is because it saves on cost if <20% enriched virgin feedstock were used when manufacturing the 10.1 and 12.1% enriched pins. The total amount of virgin U235 needed for a core is invariant, but its cost depends on the enrichment level at which it is purchased.

The blending may not perfectly attain the targeted total mass of alloy charge, Zr/U ratio and enrichment. This is because of measurement precision limitations on feedstock attributes and on weighing precision during blending. But deviations from specification may not amplify from casting batch to subsequent casting batch because the reject plus stubs component of the charge is much less than the virgin feedstock components—which presumably have smaller uncertainty in their attributes. And in any case, the completed casting product (even rejects) may have been subjected to quality control measurements of composition and enrichment.

Once the composition of the fuel slugs from a casting batch has been measured, from then on the fuel slug material may be “tracked” as it moves through the facility by use of the mass tracking (MCA) software system.

Mass Tracking Software System

The inventories and movements of all fissile containing “items” in the fabrication facility may be tracked by a Materials Control and Accountancy (MCA) software system that may be integrated with the operating staff actions on the floor. The MCA record for each “item” may record the mass and composition of the item and its location in a facility.

Physical measurements on accepted fuel slugs may be a part of the fuel slug casting operations. Mass spectroscopy may determine enrichment and wet chemistry may determine alloying diluent content. At that point properties may be directly measurable. Once the slugs become incorporated into pins, however, direct measurements (except for weight) may become impossible, so every regulatory and quality control compliance regime for control of fissile material in all subsequent process steps must rely on administrative procedures that in turn rely on MCA records.

The MCA system may maintain real-time inventories of fissile-containing material in each of Material Balance Area of a facility and vaults and may track the movements of fissile-containing “items” from one Balance Area to another.

Each and every fissile-containing “item” (such as cast slugs, fuel pins, fuel assemblies and fuel assembly clusters) may be assigned a unique identifying tag number, and the MCA software may maintain its records of heavy metal mass, composition and location organized by item identification number.

Being a database, the information can be displayed for a broad variety of organizing schemes—for example total mass by Material Balance Area or by vault number or by unique assembly number, etc.

In the Foundry, the Analytic Chemistry Lab and the Receiving Vault, the materials may be in bulk form, i.e., they are not encapsulated in cladding or in ducts that have MCA-assigned unique identification tags as is the case in the Assembly Shop and its vault. So in the Foundry, Analytic Chemistry Lab and the Receiving Vault, the materials may be boxed separately for each casting batch and the box may be identified by a unique “item” number in the MCA system. Each box can hold material of only one casting batch so that its contents will be of a single enrichment.

The storage shelves in the Foundry vault may be organized by fuel enrichment and the uniquely numbered niches for boxes may be separated into critically safe arrays. The shelves and niches and the boxes may be color coded to signal enrichment of their contents.

Every box and every storage niche may have a unique identifying number in the MCA software system

As cast slug items are incorporated into pins; as fuel pin items are incorporated into assemblies; and as fuel assembly items are collected into clusters, and as clusters are loaded into shipping casks, the MCA software may keep track of the resulting masses and compositions of the new items so created.

Periodic physical inventories conducted on the Mass Balance Areas may be used to overcheck that the MCA records remain always consistent with the physical inventories.

The MCA database may be indispensable for achieving compliance with regulatory requirements. For example, for the Criticality Safety regime, all physical material movements and processing transformations may be replicated in the virtual software “universe” of the MCA so that the distribution and composition of all fissile material throughout the facility may be knowable in real time at all times. In this way, both the mass limits by Material Balance Area used for criticality safety and the safeguards regimes can be maintained under administrative control. Proposed movements of items may first be checked for compliance with criticality safety constraints using the MCA database before they are physically executed.

For the Quality Control regime, product quality control records may be generated using the MCA database.

The roles of the MCA for implementation of the various compliance regimes are discussed below.

### Regulatory Compliance Regimes

### General

A fabrication facility operating on enriched uranium (and plutonium) feedstock may be subject to numerous regulatory compliance regimes including: product quality control regime; criticality safety regime; safeguards and material control and accountancy regime; radiological safety regime; fire safety regime and physical security regime.

These regimes may be implemented by reliance on controlled access to the fabrication facility and on strict control of fissile material movements and local inventories within the facility.

The facility may be an actively guarded controlled access space and fissile-containing inventories of in-process items and finished product may be stored in vaults.

The facility workspaces and vaults may be subdivided into administrative Material Balance Areas for administrative control of enriched uranium for Material Safeguards and for Criticality Safety purposes,

In certain embodiments, those Mass Balance Areas may be: (1) a receiving vault holding feedstock and archival casting samples; (2) a Foundry and its associated vaults that hold finished fuel slugs, recycle scrap and broken molds, each boxed and tagged by a unique casting batch number; (3) an Assembly Shop and associated vault holding finished and in-process assemblies and clusters; and (4) a rail siding holding loaded shipping casks.

Transfers of items from one Mass Balance Area to another will be tracked in real time using the Mass Tracking Software system.

### Details of the Implementation of Regulatory Compliance Regimes

### Implementation of Quality Control Regime

The performance and especially the safety of the reactor demands that the fuel amount and distribution in the core has been manufactured to specification. For example, one could not permit a higher enrichment fuel slug to be erroneously loaded into a lower enrichment fuel pin or for a higher enrichment fuel pin to be loaded into a lower enrichment assembly because that may lead to local overheating and may likely cause cladding rupture. Likewise, the closure welds on all cladding upper and lower end caps must be sound to avoid loss of pin integrity while in service.

A Quality Control regime may be instituted to assure that all pieces of the core are manufactured and assembled in conformance with specification, and of relevance here, quality assurance of nuclear fuel must be guaranteed. Quality assurance principles may be embedded in all manufacturing procedures, a training program may be instituted and a quality assurance department may administer programs to assure the quality of the final product.

In the Foundry, composition is directly measurable. After a casting batch has cooled, a sheared-off segment may be measured by mass spectroscopy to assure that the enrichment is within specification. Wet chemistry analysis may be used to check that the ratio of alloying element to uranium is within specification. Since the casting is known to be compositionally homogeneous, these measured compositions may be assigned in the Mass Tracking data base to all products of that casting batch. Weights and dimensions of accepted cast slugs may be measured directly as a part of the pin loading process.

Once outside the Foundry and into the Assembly Shop, direct measurements are no longer possible, and Quality Control may depend on administrative control—relying on the MCA software system. Tracking of the movements of fissile containing “items” as they are assembled into pins and assemblies and clusters may facilitate staff manufacturing actions.

Several concepts applicable to the exemplary core configuration used here may help to facilitate quality control. For example, any one pin contains slugs all may have the same enrichment. Similarly, any one assembly contains pins all may have the same enrichment. All pin claddings may be of the same dimensions; and all assembly ducts may be of the same geometry.

Complexity may enter at the level of the cluster designs. Clusters may span across core radial enrichment zones so they can hold assemblies of different enrichments. Similarly, clusters may span across different orifacing zones, and they may contain not only fuel assemblies, but control rod assemblies as well. Therefore, each cluster pole piece may be splined in a unique way such that it can enter only its unique position on the grid plate and only in a specific azimuthal orientation. Therefore, when positioning the fuel and control assemblies to manufacture each unique 7-assembly cluster, it is essential that they be placed in their unique designated location. A color-coded template unique to each of the 14 clusters may be used to guide operating staff actions.

There are a few places in the Assembly Shop processes where a weight measurement may serve as a simple overcheck. For example, if a fuel slug had been erroneously inserted into pin cladding in place of an intended steel lower reflector, the pin may be overweight—and vice versa. If a pin had been omitted from an assembly, the assembly may be underweight. And if a cluster had the wrong number of control assemblies, the weight may be off specification.

Pulsed neutron die-away measurements on a cluster may be used to overcheck for total U235 content of a cluster. This would not be an absolute measure of mass but rather a “signature” for comparison to a standard. This measurement may also be used at the receiving reactor site to confirm that the post-shipment signature matches the per-shipment signature—assuring that no diversion of fissile material had taken place during shipment. This physical check may support the formal transfer of safeguards records and responsibility for the fissile material from the Fuel Fabrication Facility to the reactor site.

### Implementation of a Criticality Safety Regime

All uranium in the facility may be <20% enriched. In certain embodiments, fuel pins may be manufactured at three enrichments: 10.1, 12.1 and 17.2% enriched. Uranium of different enrichments all looks the same. Color coding may be employed wherever possible to provide a visual signal to workers what enrichment they are dealing with.

Although no single free standing item (a pin, a 127 pin assembly or even a 7-assembly cluster) can go critical by itself, two criticality hazards exist:
accumulations of closely spaced items can go critical (this applies especially to boxes containing cast 17.2% enriched fuel slugs), and
introduction of moderating materials and/or of neutron-reflective materials near to fissile material might take an otherwise subcritical item to critical.

A rigorous criticality safety regime may be implemented to preclude criticality accidents. It may include:
equipment configurations that physically preclude attaining a critical mass, with margin (e.g., crucible volume);
vault storage array configurations and item spacings that preclude attaining a critical mass, with margin;
operational rules that limit the mass of fissile and reflective material at each work station, with margin;
administrative rules that limit and control the presence of moderating and reflective materials at all storage areas and work stations, with margin; and
worker training.

For the design of the facility and its equipment, rigorous modeling and calculations of the range of configurations anticipated at every work station may guide operating mass limit rules for that station.

Similarly, calculations may guide configurations for storage racks in the vaults, accounting for the hydrogenous materials in the walls, floor and ceiling and for the reflecting and moderation properties of operating staff as they move in the vaults.

In the vaults and indeed throughout the facility moderating materials must be separated from fissile-containing materials, because neutron moderation decreases critical mass. For that reason, the MCA software may track the movements of items of moderating materials as well as fissile materials so that criticality control requirements can be enforced.

Workers are themselves moderators and reflectors of neutrons. The work stations and the processing batch size may be designed taking into account the presence of workers performing “hands on” operations.

The work areas and the storage vault arrays may be divided into separate Material Balance Areas. Proposed movements of items among Balance Areas may first be checked for compliance with criticality safety constraints—not only at the terminus location but also everywhere along the transit route. This may be a function of the MCA software system.

Worker training may emphasize operating procedures as well as emergency response. The training may follow a formal process with mandatory periodic refresher courses.

### Implementation of Safeguards and Material Control and Accountancy Regime

The facility workspaces and vaults may be subdivided into administrative Material Balance Areas for safeguards control of enriched uranium and/or plutonium for material Safeguards purposes,

In certain embodiments, those Mass Balance Areas may be: (1) a receiving vault holding feedstock and archival casting samples; (2) a Foundry and its associated vaults that hold finished fuel slugs, recycle scrap and broken molds, all boxed and tagged by a unique casting batch number; (3) an Assembly Shop and associated vault holding finished and in-process assemblies and clusters—each pin, each assembly and each assembly cluster with its own unique tag number; and (4) a rail siding holding loaded shipping casks.

Transfers of items from one Mass Balance Area to another may be tracked in real time using the Mass Tracking Software system.

Safeguards inventory records may be based on the MCA database, and periodic physical inventories conducted on the Mass Balance Areas may be used to over check that the MCA records remain always consistent with the physical inventories.

In the Foundry, sampling of boxes and physical measurements may be used to confirm the inventories that are posted from the Mass Tracking System.

Once a pin is welded shut, “item accountancy” becomes sufficient, i.e., all properties of the pin (including weight of its contained uranium, the enrichment of uranium and the mass of alloying diluents) are recorded in the MCA software for the pin itself and thereafter their weights and compositions need not be physically measured again until 20 years hence when the pin gets decladded at a PYRO recycle center.

### Implementation of Radiological Safety Regime

The Fuel Fabrication facility may house up to 60 tons or more of metallic uranium (twice that for 2-shift operations) of <20% enrichment. It may also house several tons of sodium in solid form.

Operations may take these materials to liquid state at high temperatures, i.e., approximately 1400 C during uranium casting and approximately 500 C during sodium settling.

As compared to the materials encountered in a used fuel recycle facility, where the materials are highly radioactive, the inventories and operations encountered here present only modest radiological hazards to the workers and to the public. The uranium is only mildly radioactive with a glacially-slow natural decay chain producing the noble gas, Radium, and its hard gamma emitting Polonium daughters. Moreover, the facility houses no toxic chemicals. Operations are conducted “hands on” in hoods and glove boxes rather than remotely behind shielding.

Even so, uranium constantly emits Radon which decays to form gamma-emitting Polonium daughters. Since the facility contains a very large mass of bare uranium metal, the concentrations of Radon and Polonium may build up to unhealthy levels unless the atmosphere of the facility where bare uranium is present is constantly purged and renewed.

Therefore, the air atmosphere in the Foundry zone of the facility where bare uranium is handled may be maintained at a slightly negative pressure relative to ambient, and constantly purged and renewed with fresh ambient air. Before release of the exhaust air to the outside atmosphere, that release may be HEPA filtered to capture the Polonium (that is attached to particles of dust) and to capture any particles of uranium oxide that may have entered the workspace atmosphere during the handling of bare uranium metal in the hoods.

The Radon, being a gas, is not captured in the filters, thus requiring that its discharge to the ambient atmosphere be done atop a high stack so as to ensure its adequate dilution to safe levels and its subsequent dispersal.

In certain embodiments, there may be three HVAC atmosphere control zones in the facility: (1) for the Foundry, including the pin loading workspaces, where bare uranium is handled, and including the Foundry Vaults; (2) for the workspaces in the Assembly Shop where encapsulated uranium is handled, including its vaults, and (3) for an office part of the facility.

There may be a nuclear safety grade negative pressure zone with filtered release that serves the Foundry areas where bare uranium is handled, whereas normal HVAC zones are used everywhere else.

The negative pressure zone may require entry and exit through airlocks.

### Implementation of Fire Safety Regime

Operations may be conducted on flammable materials, such as sodium and uranium metals—taking them to high temperatures, thus creating a potential fire hazard. A uranium metal fire would generate slightly radioactive uranium oxide aerosols.

Since water cannot be used for fire suppression (criticality issue), fires may be snuffed out by flooding the domain of the fire with an inert gas such as N₂ or CO₂.

But controlling the fire hazard presents a conflict with the other facility safety goal, to maintain a continuous purge and filtered release of the Foundry work space atmosphere, because the atmosphere control system would suck in fresh air thereby feeding the fire with renewed oxygen supply.

The proposed solution is to maintain the always-operating atmosphere purge and filtered release of the work space atmosphere, while at the same time providing for work-station-dedicated, safety-grade fire suppression capability at those work stations where bare uranium or bare sodium may be handled, as well as for all vaults. In particular:
the sodium storage and sodium slug preparation room may be maintained at a low temperature and may have a dedicated safety-grade gas injection fire suppression system;
each casting furnace may have a movable closet—equipped with a safety-grade gas injection fire suppression system—that can be rolled into position enclosing the furnace during its heating cycle and rolled out of the way at other times;
the sodium settling station may be equipped with a dedicated gas injection fire suppression system should there be a bad fuel pin closure weld—causing a Na leak and sodium fire during the settling operation
each storage vault may have a dedicated inert gas injection fire suppression system.

In this way a static, inert gas atmosphere can be injected and maintained to snuff a fire at those locations where a fire is most likely to happen.

Any combustion products may be limited in amount and may be confined to a controlled volume where they subsequently can be cleaned up, while at the same time, the general work space remains habitable.

Worker training may combine fire safety and radiological safety in a coordinated way.

### Implementation of Physical Security Regime

A Physical Security Regime may be implemented through the physical design of the facility, in combination with operational and institutional procedures, and worker training.

The facility's capability to suppress and contain internal hazards have been outlined above.

Its ability to hold out external challenges may confront the usual ensemble of external challenges including natural phenomena such as high winds, floods, earthquakes, etc. and designated “design basis” human threats such as bombs, terrorist attacks, etc.

The first line of defense to such external challenges may be an operational requirement to return and secure all uranium-containing items into the storage vaults upon notification of imminent exposure to an external threat. The vaults may have (fast neutron) criticality safe storage arrays and always-present restraints on stored items such that a design basis earthquake cannot dislodge the materials and produce a pile of loose items on the floor that would go critical. With the vault door closed and secured, it may be watertight and may preclude water entry (and its exacerbation of criticality risk) even if the operating floor becomes flooded.

The walls, floor and ceiling of the vaults may be made of thick reinforced concrete resistant to breach under earthquake, bomb and high wind design loads. The exclusion of water entry may preclude a requirement for (thermal neutron) subcritical storage array spacing. The vault's ventilation and inert gas ducts may be valved shut upon emergency vault lockdown.

Even if there is insufficient warning time to remove and secure all uranium from the workstations, such “at risk” material that is present on the operating floor may none-the-less constitute but a small fraction of the total facility inventory of uranium. A partial lockdown of only that material that is already in the vaults, would still constitute a significant safety advantage.

The second line of defense against external hazards is the building itself. It may be windowless and designed to the Uniform Building Code for specified design basis loadings. It may thus repel high winds, snow loads, heavy rains, etc. It may remain intact after design basis earthquakes.

As regards to external terrorist attack, an armed guard force will always be present, a double security fence will surround the facility and the guard post may be constructed as a secure bunker and will have secure communication links to local law enforcement authorities.

### Applicability to Other Fuel Systems

Certain embodiments described herein may be adapted to fabricate metal alloy fuel pins and assemblies other than those exemplary systems described herein. Certain embodiments may accommodate a broad range of pin and assembly dimensions and configurations. For example, certain fuel pins and assemblies may be fabricated to operate with two meters of fuel slug, not the 1.5 meters as described above. This may make the fuel pins and assemblies taller. Also, many fast reactors have shorter fuel heights of approximately one meter, but have large ducts with hundreds of pins per assembly. The number of pins may vary from approximately 127 to over 300, so the assembly duct flat-to-flat dimensions and the weight of assemblies increases dramatically. The upper and lower fittings on pins and assemblies will be reactor specific. The type of steel used for claddings and for ducts may vary between austenitic and ferritic.

More than just dimensions, potential compositions are also of several types:
U/Zr of 0% enrichment (i.e., depleted U blankets);
U/Zr of <20% enrichment; or
U/Pu/Zr of fissile/HM up to ˜27% (using pure Pu with no minor actinides).

Enrichment levels of uranium may vary from depleted uranium (for blankets) up to <20% for driver assemblies.

Although the foregoing descriptions are directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method of fabricating metallic nuclear fuel, the method comprising:
preparing a metal feedstock charge;
injection casting the metal feedstock charge into one or more molds to form one or more injection cast fuel slugs;
determining one or more properties of the one or more injection cast fuel slugs;
inserting one or more injection cast fuel slugs with acceptable properties into one or more jackets to form a plurality of fuel pins; and
producing at least one multi-pin fuel assembly per day by assembling at least a portion of the plurality of fuel pins, wherein each multi-pin fuel assembly comprises at least one hundred fuel pins.

2. The method of claim 1, wherein each of the at least one multi-pin fuel assemblies requires injection casting of approximately 150 kg to approximately 350 kg of enriched uranium per day.

3. The method of claim 1, wherein each of the plurality of fuel pins has an axial length of approximately 3 m to approximately 5 m.

4. The method of claim 1, wherein preparing the alloy charge comprises blending two or more metal feedstocks prior to injection casting.

5. The method of claim 1, wherein preparing the alloy charge comprises determining a metal feedstock ratio by a graphics-based procedure.

6. The method of claim 1, wherein the one or more molds are one or more VYCOR or zirconium tubes.

7. The method of claim 1, wherein the injection casting is performed by two or more injection casting furnaces operating in parallel.

8. The method of claim 1, further comprising shearing to length the one or more injection cast fuel slugs prior to insertion into the one or more jackets.

9. The method of claim 1, further comprising rejecting one or more injection cast fuel slugs that do not meet predetermined properties, and storing the rejected one or more injection cast fuel slugs for future castings.

10. The method of claim 1, further comprising transferring the one or more fuel pin assemblies into a bonding furnace, and sodium bonding the one or more injection cast fuel slugs and the one or more jackets.

11. The method of claim 1, further comprising attaching top or bottom end closures to the one or more fuel pins.

12. The method of claim 1, further comprising wire wrapping the one or more fuel pins.

13. The method of claim 1, further comprising sodium bonding the one or more fuel pins and settling the sodium thermal bond.

14. The method of claim 1, further comprising assembling a plurality of multi-pin fuel assemblies into a multi-assembly cluster.

15. The method of claim 1, wherein the one or more fuel pins are less than 20% enriched.

16. The method of claim 1, wherein the one or more fuel pins are plutonium-based.

17. The method of claim 1, further comprising monitoring one or more regulatory compliance aspects using one or more administrative systems selected from the group consisting of: quality assurance, material control and accountancy, criticality safety, radiological safety, fire safety, and physical safety.

18. The method of claim 1, further comprising tracking mass of radioactive materials using a mass tracking software system.

19. A system for fabricating metallic nuclear fuel, the system comprising:
an injection casting furnace for injection casting an metal feedstock charge to create one or more injection cast fuel slugs;
an analysis unit for determining one or more properties of the one or more injection cast fuel slugs;
a jacket insertion unit for inserting one or more injection cast fuel slugs with acceptable properties into one or more jackets;
a bonding furnace for sodium bonding the one or more injection cast fuel slugs and the one or more jackets into one or more fuel pin assemblies; and
an assembler for assembling a plurality of fuel pin assemblies into a multi-pin fuel assembly,
wherein the system is adapted to produce at least one multi-pin fuel assembly per day, wherein each multi-pin fuel assembly comprises at least one hundred fuel pins.

20. The system of claim 19, wherein each of the at least one multi-pin fuel assemblies requires injection casting of approximately 150 kg to approximately 350 kg of enriched uranium per day.

21. The system of claim 19, wherein each of the plurality of fuel pins has an axial length of approximately 3 m to approximately 5 m.

22. The system of claim 19, further comprising two or more injection casting furnaces operating in parallel.

23. The system of claim 19, further comprising a cluster assembly unit for assembling a plurality of multi-pin fuel assemblies into multi-assembly clusters.

24. The system of claim 23, further comprising one or more administrative systems selected from the group consisting of: quality assurance, material control and accountancy, criticality safety, radiological safety, fire safety, and physical safety.

25. The system of claim 23, further comprising a mass tracking software system.
